(19) United States
(12) Patent Application Publication
(10) Pub. No.: US 2015/0331897 A1
(43) Pub. Date: Nov. 19, 2015

(54) INFORMATION PROCESSING APPARATUS, INFORMATION PROCESSING METHOD, AND NON-TRANSITORY COMPUTER READABLE MEDIUM

(71) Applicant: FUJI XEROX CO., LTD., Tokyo (JP)

(72) Inventor: Bin ZHOU, Kanagawa (JP)

(21) Appl. No.: 14/572,960

(22) Filed: Dec. 17, 2014

(30) Foreign Application Priority Data
May 14, 2014 (JP) 2014-100261

(51) Int. Cl. G06F 17/30; G06F 19/00

(52) U.S. Cl. CPC G06F 17/30371; G06F 19/324; G06F 17/30575

(57) ABSTRACT

An information processing apparatus includes a first determination unit determining whether a storage period of a target document expires on the basis of a first table in which type information, creation department information, and the storage period determined by a period from a document reviewed time are associated with each other using the type information and the creation department information about the target document; a second determination unit determining whether the storage period of the target document expires on the basis of a second table in which medical care department information is associated with the storage period using the information indicating the medical care department where the target document is reviewed; and a deletion unit that, if the storage period of the target document expires, performs any of deletion of the target document from a memory storing the target document, compression, and movement to another document memory.

### CROSS-REFERENCE TO RELATED APPLICATIONS

This application is based on and claims priority under 35 USC 119 from Japanese Patent Application No. 2014-100261 filed May 14, 2014.

### BACKGROUND

### Technical Field

The present invention relates to an information processing apparatus, an information processing method, and a non-transitory computer readable medium.

### SUMMARY

According to an aspect of the invention, there is provided an information processing apparatus including a first determination unit that determines whether a storage period of a target document expires on the basis of a first table in which type information indicating a type of each document concerning medical care, creation department information indicating a department where the document is created, and the storage period determined by a period from a time when the document is reviewed are associated with each other using the type information and the creation department information about the target document; a second determination unit that determines whether the storage period of the target document expires on the basis of a second table in which medical care department information indicating a medical care department is associated with the storage period determined by the period from the time when the document concerning the medical care is reviewed using the medical care department information indicating the medical care department where the target document is reviewed; and a deletion unit that, if the first determination unit and the second determination unit determine that the storage period of the target document expires, performs any of deletion of the target document from a memory in which the target document is stored, compression of the target document, and movement of the target document to another document memory.

### BRIEF DESCRIPTION OF THE DRAWINGS

Exemplary embodiments of the present invention will be described in detail based on the following figures, wherein:

FIG. 1 illustrates an exemplary conceptual module configuration of an information processing apparatus according to an exemplary embodiment;

FIG. 2 illustrates an exemplary system configuration when the present exemplary embodiment is realized;

FIG. 3 is a flowchart illustrating an exemplary process according to the present exemplary embodiment;

FIG. 4 is a flowchart illustrating an exemplary process according to the present exemplary embodiment;

FIG. 5 illustrates an exemplary data structure of a copy rule table;

FIG. 6 illustrates an exemplary data structure of a storage policy table;

FIG. 7 illustrates an exemplary data structure of a viewing record table;

FIG. 8 illustrates an exemplary data structure of a patient special record; and

FIG. 9 is a block diagram illustrating an exemplary hardware configuration of a computer realizing an exemplary embodiment.

### DETAILED DESCRIPTION

Exemplary embodiments of the present invention will herein be described with reference to the attached drawings.

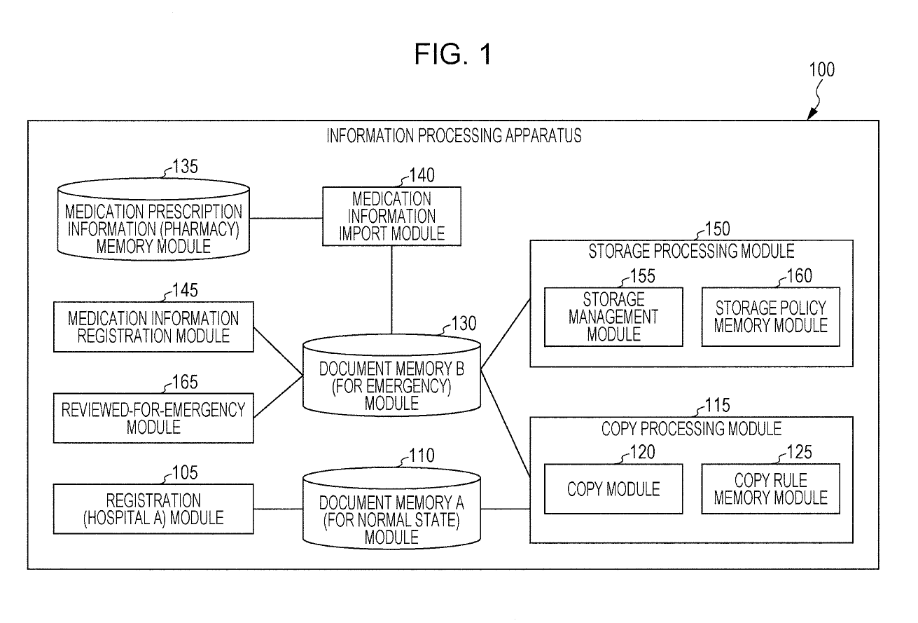

FIG. 1 illustrates an exemplary conceptual module configuration of an information processing apparatus according to an exemplary embodiment.

The modules generally mean parts including software (computer programs) and hardware, which are capable of being logically separated. Accordingly, the modules in the present exemplary embodiment mean not only the modules in the computer program but also the modules in the hardware configuration. The computer program causing the computer to function as the modules (a program causing the computer to execute the respective procedures, a program causing the computer to function as the respective parts, or a program causing the computer to realize the respective functions), a system, and a method are described in the present exemplary embodiment. Although “store”, “causing the computer to store”, and similar phrases are used for convenience, these phrases mean storing the computer program in a memory or causing the computer to store the computer program in the memory when the computer program is embodied. Although the module may have one-to-one correspondence with the function, one module may be composed of one program, multiple modules may be composed of one program, or one module may be composed of multiple programs in installation. The multiple modules may be executed by one computer or one module may be executed by multiple computers in distributed or parallel environment. Other modules may be included in one module. “Connection” is hereinafter used not only for physical connection but also for logical connection (exchange of data, instruction, and reference relationship between pieces of data). “Predetermined” means that something is determined before a target process and includes, in addition to the determination before the process according to an exemplary embodiment is started, determination based on the current status or state or the past status or state before the target process even if the process according to the exemplary embodiment is started. When multiple “predetermined values” exist, the predetermined values may be different from each other or two or more (including all) of the multiple predetermined values may be equal to each other. A description meaning that “B is performed if A” is used to mean that “it is determined whether A and, if it is determined that A, B is performed.” However, cases in which the determination of whether A is not performed are excluded.

Each of the system and the apparatus may be realized by one computer, one piece of hardware, one unit, or the like, in addition to a configuration in which multiple computers, multiple pieces of hardware, multiple units, and the likes are connected to each other via a communication unit, such as a network (including one-to-one correspondence communication connection). The “apparatus” and the “system” are used as synonyms. The “system” does not include a social “mechanism” (social system), which is artificial agreement.

When multiple processes are performed for every process in each module or in the module, target information is read out from the memory for each process, the process is performed, and the result of the process is written out onto the memory. Accordingly, a description of the reading from the memory before the process and writing out onto the memory after the process may be omitted. The memory may be a hard disk, a random access memory (RAM), an external storage medium, a memory via a communication line, a register in a central processing unit (CPU), or the like.

An information processing apparatus 100 according to the present exemplary embodiment manages documents that are backed up and that concern medical care. Referring to FIG. 1, the information processing apparatus 100 includes a registration (hospital A) module 105, a document memory A (for normal state) module 110, a copy processing module 115, a document memory B (for emergency) module 130, a medication prescription information (pharmacy) memory module 135, a medication information import module 140, a medication information registration module 145, a storage processing module 150, and a reviewed-for-emergency module 165.

It is sufficient for the information processing apparatus 100 to at least include a storage management module 155 or the storage processing module 150. The other modules may be provided in another information processing apparatus capable of communicating with the information processing apparatus 100.

A desired document is desirably identified from all documents that are back up to review the document in order for a doctor to perform medical care (including examination, treatment, etc.) of a patient who has visited a hospital or the like in an emergency, such as in a disaster. The document means an electronic document here. The document is mainly text data and, in some cases, electronic data indicating graphics, images, movies, audio, etc. or a combination of the text data and the electronic data. The document is the one that is subjected to storage, editing, search, and so on and that is capable of being exchanged between systems or users as an individual unit and may be the one similar to the above one. Specifically, the document is a document created by a document creation program, a Web page, or the like.

In the current situation, only the documents in specific medical facilities (including hospitals, clinics, and welfare facilities) are capable of being reviewed, and confirmation of documents concerning the results of the medical care in other medical facilities and information about medication prescribed in the treatment in the other medical facilities is unavailable.

Documents different from the documents used in normal medical care (first visit) are often used in order to provide the medical care to a patient who visits the hospital or the like (in particular, a patient who has already received the medical care in other medical facilities) in an emergency. For example, since information indicating the past medical history, dosing information, allergy, and a home doctor of the patient who visits the hospital or the like is desirably acquired, the document in which the above information is described is desirably prepared.

In this situation, a document memory apparatus that stores (backs up) documents concerning the medical care in multiple medical facilities is proposed. The document memory apparatus for backup is provided in other locations (for example, as a cloud on the Internet) to make the documents accessible also in disasters.

Since there is an upper limit to the capacity of the document memory apparatus and the documents stored in the document memory apparatus get old, the documents the usability of which is decreased should be deleted in emergencies. The document may be compressed or moved to other document memory apparatus, instead of the deletion. Any of the deletion, the compression, and the movement to another document memory apparatus is hereinafter referred to as deletion or the like.

Referring to FIG. 1, the registration (hospital A) module 105 is connected to the document memory A (for normal state) module 110. The registration (hospital A) module 105 registers a document (a document concerning the medical care of each patient) used in a hospital A.

The document memory A (for normal state) module 110 is connected to the registration (hospital A) module 105 and the copy processing module 115. The document memory A (for normal state) module 110 stores the documents concerning the medical care. For example, the document memory A (for normal state) module 110 is a document storage repository used in normal examination in the hospital A. The document memory A (for normal state) module 110 adds information indicating a patient identifier (ID), a document type, a medical care department, and so on to each document stored in the document memory A (for normal state) module 110 for record. The document memory A (for normal state) module 110 is intended to be used in the normal medical care and conforms to a legal storage period (for example, five years) of each document.

Although the registration (hospital A) module 105 and the document memory A (for normal state) module 110 are, for example, managed and used in the hospital A, the registration (hospital A) module 105 and the document memory A (for normal state) module 110 are not limitedly managed and used in the hospital A. It is sufficient for the registration (hospital A) module 105 and the document memory A (for normal state) module 110 to be managed and used in a medical facility and multiple registration (hospital A) modules 105 and multiple document memory A (for normal state) modules 110 may be provided.

The copy processing module 115 includes a copy module 120 and a copy rule memory module 125. The copy processing module 115 is connected to the document memory A (for normal state) module 110 and the document memory B (for emergency) module 130. The copy processing module 115 copies a document in the document memory A (for normal state) module 110 to the document memory B (for emergency) module 130. Multiple document memory A (for normal state) modules 110 may be provided.

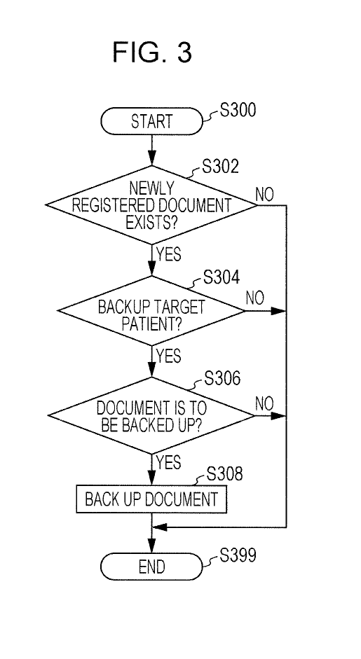

The copy module 120 provides a function to copy the document from the document memory A (for normal state) module 110 to the document memory B (for emergency) module 130 in accordance with a copy rule in the copy rule memory module 125. In other words, the copy module 120 backs up the document. Specifically, the copy module 120 copies the document concerning predetermined type information and creation department information from the document memory A (for normal state) module 110 to the document memory B (for emergency) module 130. The copy module 120 also copies the information indicating the patient ID (information for uniquely identifying the patient in the present exemplary embodiment), the document type, the medical care department, and so on added to each document, in addition to the content of the document, in the copying. An exemplary process performed by the copy module 120 will be described below with reference to a flowchart in FIG. 3.

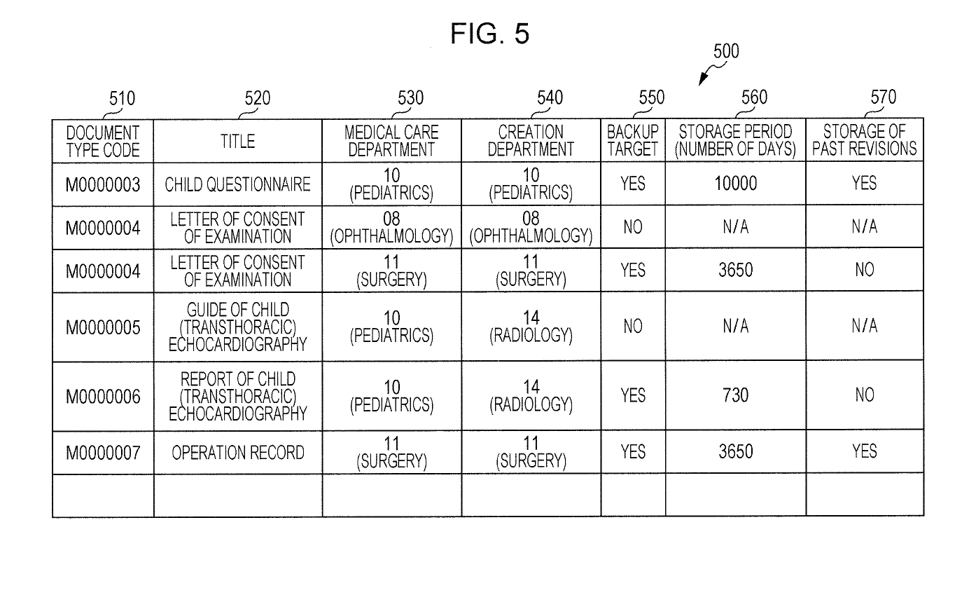

The copy rule memory module 125 does not copy all the documents of the patient in the document memory A (for normal state) module 110 but stores a definition rule in which the documents used in emergencies are defined in advance as the documents to be backed up. The copy module 120 copies the document to the document memory B (for emergency) module 130 in accordance with the definition rule. The predetermined type information and creation department information are defied as the definition rule and the copy module 120 copies the document conforming to the definition rule. Specifically, it is determined whether the document is to be backed up on the basis of information stored in a document type code field 510 and a creation department field 540 in a copy rule table 500 described below illustrated in FIG. 5 (or information stored in a backup target field 550 in the copy rule table 500).

The copy rule memory module 125 may store a rule used to determine whether the copying is to be performed also using multiple pieces of information, for example, the document creation department, the hospital admission state of the patient, and illness of the patient. The copy module 120 performs the copying in accordance with the rule.

The document memory B (for emergency) module 130 is connected to the copy processing module 115, the medication information import module 140, the medication information registration module 145, the storage processing module 150, and the reviewed-for-emergency module 165. The document memory B (for emergency) module 130 stores the documents concerning the medical care. For example, the document memory B (for emergency) module 130 is a storage repository of the documents and the medication information used in disasters and emergencies. The document memory B (for emergency) module 130 records and manages the documents in each hospital and the medication information in each pharmacy. The document memory B (for emergency) module 130 is intended to store the documents for emergency. Although the document memory B (for emergency) module 130 may store each document for a period longer than the legal storage period of the document, the document may be deleted before the storage period expires in order to remove unused data.

The data to be stored in the document memory B (for emergency) module 130 is recorded in the following three manners:

1. Copying from the document memory A (for normal state) module 110 (the copy module 120)

2. Medication information registered by the patient (the medication information registration module 145)

3. Medication information imported from a pharmacy (the medication information import module 140)

The medication prescription information (pharmacy) memory module 135 is connected to the medication information import module 140. Medication prescription information from each medical facility of each patient is accumulated in the medication prescription information (pharmacy) memory module 135 in the pharmacy. A standard data format of Japanese Association of Healthcare Information Systems Industry (JAHIS) exists. For example, the data format is prescribed in JAHIS technical document 13-103. “Electronic medication notebook data format specifications Version 1.1” is described in, for example,

“http://www.jahis.jp.jahishyojun13-103/.”

The medication information import module 140 is connected to the document memory B (for emergency) module 130 and the medication prescription information (pharmacy) memory module 135. The medication information import module 140 stores the medication information about the patient concerning the document from the medication prescription information in the pharmacy in the document memory B (for emergency) module 130. For example, specifically, the medication information import module 140 imports electronic medication notebook data from the medication prescription information (pharmacy) memory module 135 managed in the pharmacy into the document memory B (for emergency) module 130. The medication information import module 140 allows the medication information in other medical facilities to be stored in the document memory B (for emergency) module 130.

The medication information registration module 145 is connected to the document memory B (for emergency) module 130. The medication information registration module 145 stores the medication information registered by the patient in the document memory B (for emergency) module 130. For example, the medication information registration module 145 allows the patient to register the information about the medication that is taken by the patient. Specifically, the patient may register the medication information prescribed in another medical facility using the information processing apparatus provided in the medical facility. Alternatively, the patient may register the medication information using a mobile phone (including a smartphone) of the patient. The data that is registered here complies with the standard data format in the JAHIS.

The storage processing module 150 includes the storage management module 155 and a storage policy memory module 160. The storage processing module 150 is connected to the document memory B (for emergency) module 130. The storage processing module 150 has a function to manage the data in the document memory B (for emergency) module 130.

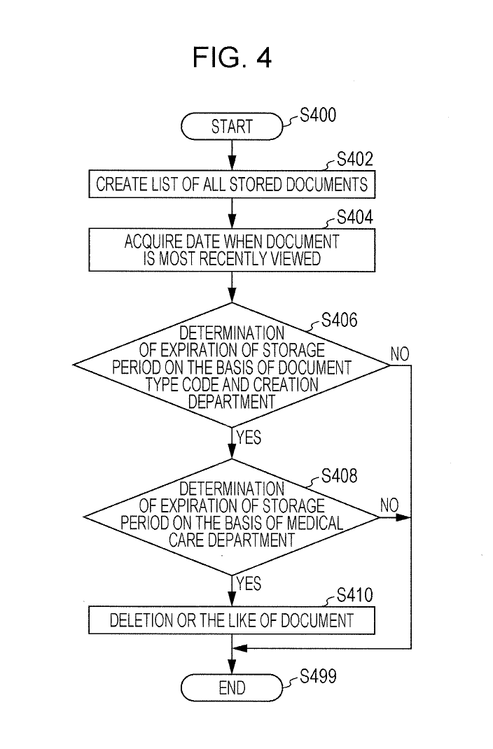

The storage management module 155 performs the deletion or the like of a disused document the storage period of which expires and which is stored in the document memory B (for emergency) module 130 on the basis of a storage policy stored in the storage policy memory module 160 in order to perform the deletion or the like of the document. The storage management module 155 determines whether the storage period of the target document expires using the type information and the creation department information about the target document on the basis of a first table stored in the storage policy memory module 160 (first determination). The storage management module 155 determines whether the storage period of the target document expires using information about the medical care department where the target document is reviewed on the basis of a second table stored in the storage policy memory module 160 (second determination). If the storage management module 155 determines that the storage period of the target document expires through the first determination and the second determination, the storage management module 155 performs the deletion or the like of the document from the document memory B (for emergency) module 130 where the document is stored. “On the basis of the first table” means that the type information and the creation department information about the target document are searched for in the first table to extract the storage period corresponding to the type information and the creation department information about the target document. The storage period of the first table may be set to a storage period defined by the period from the time when the document is created. “On the basis of the second table” means that the medical care department information where the target document is reviewed is searched for in the second table to extract the storage period corresponding to the medical care department information. An exemplary process performed by the storage management module 155 will be described below with reference to a flowchart in FIG. 4.

The storage management module 155 may determine whether the storage period of the target document expires using the information about the medical care department where the target document is reviewed and review of the target document by a person of a predetermined occupation on the basis of the second table as the second determination.

The process performed by the storage management module 155 may be performed for every predetermined period (periodically) or may be performed in response to a start operation by an operator.

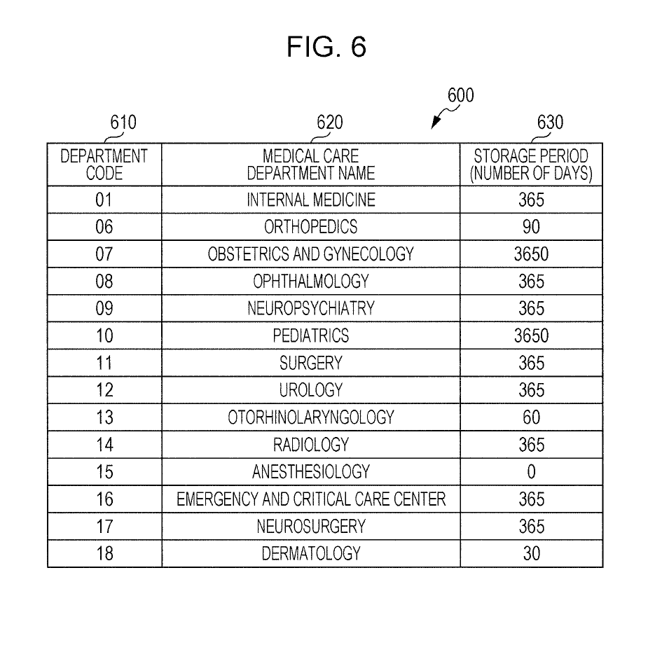

The storage policy memory module 160 sets the storage period using attributes of the document. In other words, the storage policy memory module 160 stores the first table in which the type information indicating the type of the document concerning the medical care, the creation department information indicating the department where the document is created, and the storage period defined by the period from the time when the document is reviewed are associated with each other and the second table in which the medical care department information indicating the department where the medical care is performed is associated with the storage period defined by the period from the time when the document concerning the medical care is reviewed. For example, specifically, the first table is exemplified by the copy rule table 500 in FIG. 5 and the second table is exemplified by a storage policy table 600 in FIG. 6.

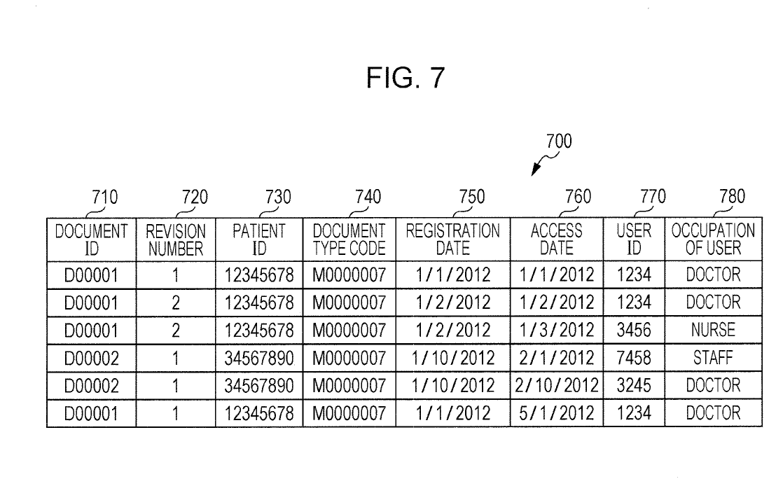

FIG. 5 illustrates an exemplary data structure of the copy rule table 500. The copy rule table 500 defines the target document to be backed up and the storage period on the basis of the type information about each document and the creation department where the document is created. Since the document concerning the medical care is varied in the degree of importance depending on the department where the document is created even with the same document type, the target document to be backed up is determined on the basis of not only the document type but also the creation department. The copy rule table 500 includes the document type code field 510, a title field 520, a medical care department field 530, the creation department field 540, the backup target field 550, a storage period field 560, and a storage of past revisions field 570. The document type code field 510 stores the document type code indicating the type of each document. The title field 520 stores the title in the type of the document. The medical care department field 530 stores information indicating the medical care department used for the document. The medical care department is also a department to instruct the creation of the document. In other words, the medical care department may be different from the creation department or the medical care department may coincide with the creation department. The creation department field 540 stores information indicating the creation department. The creation department is the department to create the document in accordance with an instruction from the medical care department. The backup target field 550 stores information indicating whether the document is the target document to be backed up. The information indicating whether the document is the target document to be backed up is determined by a combination of the document type code of the document and the creation department information. Accordingly, the copy module 120 determines whether the target document is to be copied on the basis of the combination of the document type code of the document and the creation department information. The storage period field 560 stores the storage period (for example, specified by the number of days) of the document. The storage period here is calculated from the date when the document is most recently reviewed. Since the occupation (doctor or nurse) of the user who reviews the document is recorded in a viewing record table 700 illustrated in FIG. 7, only a viewing event of a predetermined occupation may be set as an update target. The storage of past revisions field 570 stores information indicating whether past revisions of the document are to be stored. In the present exemplary embodiment, revision control is performed and the storage of past revisions field 570 indicates whether the past revisions are to be backed up.

Although the copy rule table 500 illustrated in FIG. 5 defines the condition by using the combination of the type information about the document and the creation department information, a table that defines the target documents to be backed up and the storage periods based on the type information about the document and a table that defines the target documents to be backed up and the storage periods based on the creation department information may be prepared to perform the determination using both of the conditions (the type of the document and the creation department).

In the example in FIG. 5, “N/A” in the storage period field 560 may be represented by “zero (0)” and the “N/A” in the storage of past revisions field 570 may be represented by “NO.”.

FIG. 6 illustrates an exemplary data structure of the storage policy table 600. The storage policy table 600 defines the storage period for every medical care department. Because of the configuration of the information processing apparatus 100, the document stored in the document memory B (for emergency) module 130 also exists in the document memory A (for normal state) module 110. The document that is reviewed in the normal medical care is probably used in emergencies. The access date when each document is accessed is recorded in the document memory A (for normal state) module 110, for example, in the format of the viewing record table 700 illustrated in FIG. 7. The storage period is not calculated on the basis of the date when the document is registered but is calculated from the date when the document is most recently reviewed. Since the occupation (doctor or nurse) of the user who reviews the document is recorded in the viewing record table 700 illustrated in FIG. 7, only the viewing event of the predetermined occupation may be set as the update target. The storage policy table 600 includes a department code field 610, a medical care department name field 620, and a storage period field 630. The department code field 610 stores department codes. The medical care department name field 620 stores the name of the medical care department indicated by each department code. The storage period field 630 stores the storage period (for example, specified by the number of days) from the time when the document is reviewed by a person in the medical care department.

FIG. 7 illustrates an exemplary data structure of the viewing record table 700. The viewing record table 700 is a table in which a log of operations for each document is stored. The viewing record table 700 includes a document ID field 710, a revision number field 720, a patient ID field 730, a document type code field 740, a registration date field 750, an access date field 760, a user ID field 770, and an occupation of user field 780. The document ID field 710 stores information (document ID) for uniquely identifying each document in the present exemplary embodiment. The revision number field 720 stores the revision number of the document. The patient ID field 730 stores information (patient ID) for uniquely identifying the patient in the document in the present exemplary embodiment. The document type code field 740 stores the document type code of the document. The registration date field 750 stores the date when the document is registered. The access date field 760 stores the date when the document is accessed (reviewed). The user ID field 770 stores information (user ID) for uniquely identifying the user who accesses the document in the present exemplary embodiment. The occupation of user field 780 stores information indicating the occupation of the user.

The reviewed-for-emergency module 165 is connected to the document memory B (for emergency) module 130. The reviewed-for-emergency module 165 provides a function to allow the review of the document in an emergency, such as a case when a disaster occurs. The reviewed-for-emergency module 165 accesses the document memory B (for emergency) module 130 to allow the review of the document and the medication information about the patient, which are used in an emergency.

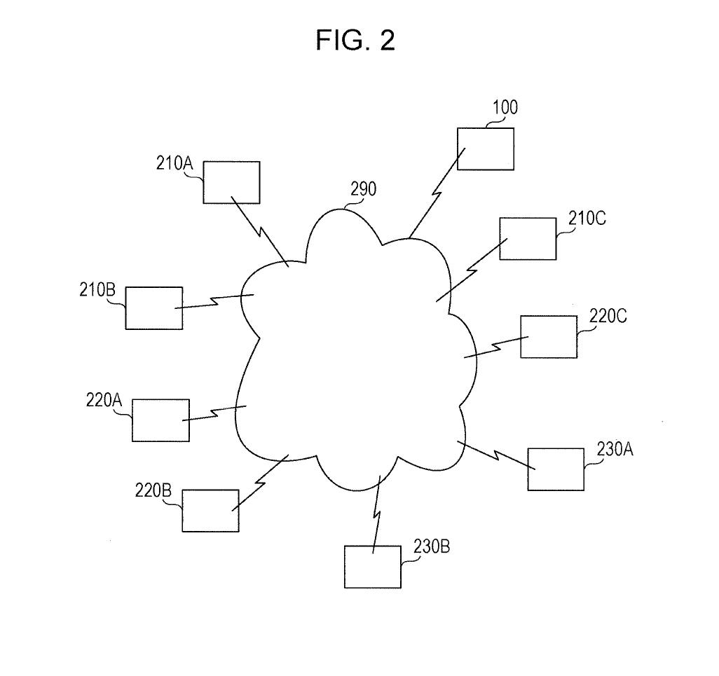

FIG. 2 illustrates an exemplary system configuration when the present exemplary embodiment is realized.

Referring to FIG. 2, the information processing apparatus 100, a hospital A system 210A, a hospital B system 210B, a clinic C system 210C, a pharmacy A system 220A, a pharmacy B system 220B, a pharmacy C system 220C, a user terminal 230A, and a user terminal 230B are connected to each other via a communication line 290. The communication line 290 may be a wireless communication line, a wired communication line, or a combination of them. The communication line 290 may be, for example, the Internet serving as a communication infrastructure.

The registration (hospital A) module 105 and the document memory A (for normal state) module 110 in the information processing apparatus 100 illustrated in FIG. 1 may be provided in each of the hospital A system 210A, the hospital B system 210B, and the clinic C system 210C. The medication prescription information (pharmacy) memory module 135 in the information processing apparatus 100 illustrated in FIG. 1 may be provided in each of the pharmacy A system 220A, the pharmacy B system 220B, and the pharmacy C system 220C.

The information processing apparatus 100 copies the document from the document memory A (for normal state) module 110 in each of the hospital A system 210A, the hospital B system 210B, and the clinic C system 210C to the document memory B (for emergency) module 130 and copies the document from the medication prescription information (pharmacy) memory module 135 in each of the pharmacy A system 220A, the pharmacy B system 220B, and the pharmacy C system 220C to the document memory B (for emergency) module 130.

In response to an operation by each user (patient), the personal medication information about the user is registered from each of the user terminal 230A and the user terminal 230B in the document memory B (for emergency) module 130 via the medication information registration module 145.

The information in the document memory B (for emergency) module 130 is accessed from the terminal used by the doctor in, for example, the hospital A system 210A via the reviewed-for-emergency module 165.

FIG. 3 is the flowchart illustrating an exemplary process performed by the copy module 120. In the exemplary process in FIG. 3, the document that is newly registered in each medical facility is copied into the document memory B (for emergency) module 130.

Referring to FIG. 3, in Step S302, the copy module 120 determines whether a document that is newly registered exists. If the copy module 120 determines that a document that is newly registered exists (YES in Step S302), the process goes to Step S304. If the copy module 120 determines that a document that is newly registered does not exist (NO in Step S302), in Step S399, the process is terminated.

In Step S304, the copy module 120 determines whether the patient is a backup target patient. If the copy module 120 determines that the patient is the backup target patient (YES in Step S304), the process goes to Step S306. If the copy module 120 determines that the patient is not the backup target patient (NO in Step S304), in Step S399, the process is terminated. A list of backup target patients is created in advance and the copy module 120 performs the determination in accordance with the list. For example, the copy module 120 may perform the determination on the basis of whether the patient's consent to copy the document is gained.

In Step S306, the copy module 120 determines whether the document is to be backed up. If the copy module 120 determines that the document is to be backed up (YES in Step S306), the process goes to Step S308. If the copy module 120 determines that the document is not to be backed up (NO in Step S306), in Step S399, the process is terminated. Whether the document is to be backed up is based on the storage policy table 600, as described above.

In Step S308, the copy module 120 backs up the document from the document memory A (for normal state) module 110 in the document memory B (for emergency) module 130.

FIG. 4 is the flowchart illustrating an exemplary process performed by the storage management module 155.

Referring to FIG. 4, in Step S402, the storage management module 155 creates a list of all the documents stored in the document memory A (for normal state) module 110.

In Step S404, the storage management module 155 acquires the date when the target document is most recently reviewed. For example, the date when the target document is most recently reviewed is acquired using the viewing record table 700 described above with reference to FIG. 7.

In Step S406, the storage management module 155 determines whether the storage period expires on the basis of the document type code and the creation department in the copy rule table 500. If the storage management module 155 determines that the storage period expires on the basis of the document type code and the creation department (with reference to the storage period field 560 determined by the document type code field 510 and the creation department field 540) (YES in Step S406), the process goes to Step S408. If the storage management module 155 determines that the storage period does not expire on the basis of the document type code and the creation department (NO in Step S406), in Step S499, the process is terminated.

In Step S408, the storage management module 155 determines whether the storage period (the storage period field 630) expires on the basis of the medical care department in the storage policy table 600. If the storage management module 155 determines that the storage period expires on the basis of the medical care department (YES in Step S408), the process goes to Step S410. If the storage management module 155 determines that the storage period does not expire on the basis of the medical care department (NO in Step S408), in Step S499, the process is terminated.

In Step S410, the storage management module 155 performs the deletion or the like of the document.

For example, the document that was registered a long time ago but is frequently referred to should not be deleted. Instead of the number of days elapsed since the registration date, the date when the document stored in the document memory A (for normal state) module 110 has been accessed (reviewed) last time is used. Specifically, in the case of the viewing record table 700 illustrated in FIG. 7, since the doctor has accessed a document D00001 on May 1, 2012 although the registration date of the document D00001 is Jan. 1, 2012, May 1, 2012 is used as the starting date for the determination of the storage period. Alternatively, the date of access from a user of a predetermined occupation (for example, doctor) may be set as the starting date of the storage period. Accordingly, access from a user of an occupation other than the predetermined occupation (for example, staff) is not be set as the starting date of the storage period.

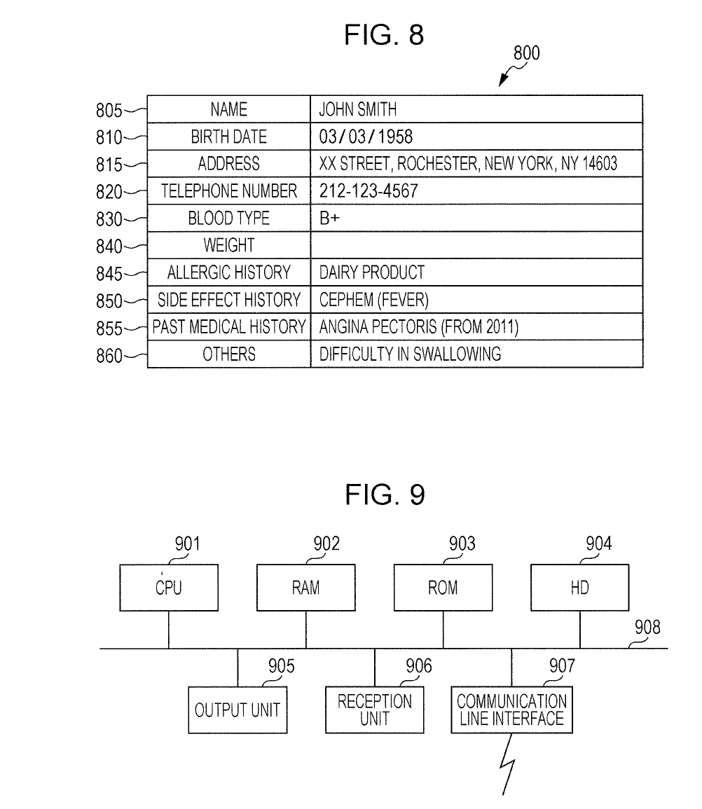

The patient usually has an examination at a clinic and gets a medication, in addition to the medical care in the hospital. The two modules (the medication information import module 140 and the medication information registration module 145) are provided in order to acquire the medication information about the patient. The patient himself/herself uses the medication information registration module 145 to register the medication which the patient takes when the patient visits the hospital. The medication information import module 140 imports prescription data from the pharmacy in the medication prescription information (pharmacy) memory module 135 into the document memory B (for emergency) module 130. Basic information (name, address, telephone number, etc.) about the patient, which is managed in each pharmacy, is concurrently registered. The reviewed-for-emergency module 165 checks patient information in the hospital on the basis of the basic information about the patient included in the prescription information and displays both of the document of the patient and the prescription data about the patient. When the prescription data in the pharmacy complies with “Electronic medication notebook data format specifications Version 1.1” of the JAHIS, a “patient special record” field is used for description of allergy, side effect of medication, a past medical history of the patient. Such data is indicated in a manner in a patient special record 800 illustrated in FIG. 8. FIG. 8 illustrates an exemplary data structure of the patient special record 800. The patient special record 800 includes a name field 805, a birth date field 810, an address field 815, a telephone number field 820, a blood type field 830, a weight field 840, an allergic history field 845, a side effect history field 850, a past medical history field 855, and an others field 860. The name field 805 stores the name of the patient. The birth date field 810 stores the birth date of the patient. The address field 815 stores the address of the patient. The telephone number field 820 stores the telephone number of the patient. The blood type field 830 stores the blood type of the patient. The weight field 840 stores the weight of the patient. The allergic history field 845 stores the allergic history of the patient. The side effect history field 850 stores the side effect history of the patient. The past medical history field 855 stores the past medical history of the patient. The others field 860 stores other information concerning the patient.

The above prescription data may be excluded from the target of processing by the storage management module 155 and all pieces of the prescription data may be stored without deletion.

Services to exchange the data in the medication notebooks of pharmacies already exist in the market. The medication information is capable of being imported in synchronization with the data exchange services for the medication notebooks in a data format common to that of such services. For example, the data is imported from the medication prescription information (pharmacy) memory module 135 in a comma-separated values (CSV) file complying with the electronic medication notebook data format. When connection with the medication prescription information (pharmacy) memory module 135 via the communication line 290 is available, the medication information import module 140 monitors the prescription data accumulated in the medication prescription information (pharmacy) memory module 135 to update a database in the document memory B (for emergency) module 130. When the connection with the medication prescription information (pharmacy) memory module 135 via the communication line 290 is not available, the prescription data stored in a recording medium, such as a digital versatile disk (DVD), may be collectively imported.

A computer in which the programs according to an exemplary embodiment are executed has the hardware configuration of a general computer, as illustrated in FIG. 9. Specifically, the computer is, for example, a personal computer or a server. More specifically, the computer uses a CPU 901 as a processor (an arithmetic unit) and uses a RAM 902, a read only memory (ROM) 903, and a hard disk (HD) 904 as memories. The computer includes CPU 901 that executes the programs of, for example, the registration (hospital A) module 105, the copy processing module 115, the copy module 120, the copy rule memory module 125, the medication information import module 140, the medication information registration module 145, the storage processing module 150, the storage management module 155, the storage policy memory module 160, and the reviewed-for-emergency module 165; the RAM 902 that stores the programs and data; the ROM 903 that stores a program to boot the computer and so on; the HD 904 that serves as an auxiliary memory (may be a flash memory); an output unit 905, such as a cathode ray tube (CRT) or a liquid crystal display; a reception unit 906 that receives data on the basis of an operation by the user with, for example, a keyboard, a mouse, or a touch panel; a communication line interface 907 to connect to a communication network, such as a network interface card; and a bus 908 via which the above components are connected to each other to exchange data. Multiple such computers may be connected to each other via a network.

In the exemplary embodiment embodied by the computer program, among the above exemplary embodiments, the system having the above hardware configuration reads the computer program, which is software, to realize the exemplary embodiment through cooperation of the software and the hardware resources.

The hardware configuration illustrated in FIG. 9 is only an example and the present exemplary embodiment is not limited to the configuration illustrated in FIG. 9 as long as the modules described in the above exemplary embodiments are capable of being executed. For example, part of the modules may be configured by dedicated hardware (for example, an application specific integrated circuit (ASIC)), part of the modules may exist in an external system and the external modules may be connected to the system via the communication line, or multiple systems illustrated in FIG. 9 are connected to each other via the communication line for collaboration. The system illustrated in FIG. 9 may be incorporated in a home information appliance, a copier, a facsimile, a scanner, a printer, or a multi-function peripheral (an image processing apparatus having two or more of the functions of the scanner, the printer, the copier, the facsimile, and so on), instead of the personal computer.

The terms “date”, “hour”, “date and time”, etc. used in the above description may indicate a year, a month, a date, a hour, a minute, a second, a unit smaller than the second, or a combination of them.

The programs described above may be stored in a recording medium for provision or the programs may be provided using a communication unit. In this case, the programs described above may be understood as an exemplary embodiment of a “computer-readable recording medium on which the programs are recorded.”

The “computer-readable recording medium on which the programs are recorded” means a computer-readable recording medium on which the programs are recorded and which is used for installation, execution, distribution of the programs.

The recording medium may be a digital versatile disk (DVD), such as a DVD-R a DVD-RW, or a DVD-RAM conforming to a standard developed in a DVD forum or a DVD+R or a DVD+RW conforming to a standard developed with DVD+RW; a compact disc (CD), such as a CD-ROM, a CD-recordable (CD-R), or a CD-rewritable (CD-RW); a Blue-ray disc (registered trademark); a magneto-optical (MO) disk; a flexible disk (FD); a magnetic tape; a hard disk; a ROM; an electrically erasable and programmable read only memory (EEPROM (registered trademark)); a flash memory; a RAM; or a secure digital (SD) memory card.

The program described above or part of the program may be recorded on the recording medium for storage or distribution. Alternatively, the program described above or part of the program may be transmitted through communication, for example, using a transmission medium composed of a wired network used for a local area network (LAN), a metropolitan area network (MAN), a wide area network (WAN), the Internet, an intranet, or an extranet; a wireless communication network; or a combination of them. The program described above or part of the program may be carried on carrier waves.

Each program described above may be part of another program or may be recorded on the recording medium along with another program. The program described above may be divided to be recorded on multiple recording media. The program described above may be recorded in any recoverable mode, such as in a compressed mode or an encoded mode.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a first determination unit that determines whether a storage period of a target document expires on a basis of a first table in which type information indicating a type of each document concerning medical care, creation department information indicating a department where the document is created, and the storage period determined by a period from a time when the document is reviewed are associated with each other using the type information and the creation department information about the target document;
a second determination unit that determines whether the storage period of the target document expires on a basis of a second table in which medical care department information indicating a medical care department is associated with the storage period determined by the period from the time when the document concerning the medical care is reviewed using the medical care department information indicating the medical care department where the target document is reviewed; and
a deletion unit that, if the first determination unit and the second determination unit determine that the storage period of the target document expires, performs any of deletion of the target document from a memory in which the target document is stored, compression of the target document, and movement of the target document to another document memory.

2. The information processing apparatus according to claim 1,
wherein the second determination unit determines whether the storage period of the target document expires on a basis of the second table using the medical care department information indicating the medical care department where the target document is reviewed and review of the target document by a person of a predetermined occupation.

3. The information processing apparatus according to claim 1, further comprising:
a copy unit that copies the document concerning the type information and the creation department information, which are predetermined, into the memory.

4. The information processing apparatus according to claim 2, further comprising:
a copy unit that copies the document concerning the type information and the creation department information, which are predetermined, into the memory.

5. The information processing apparatus according to claim 1, further comprising:
a medication information memory that stores medication information about a patient concerning the target document from medication prescription information in a pharmacy in the memory or stores medication information registered by the patient in the memory.

6. A non-transitory computer readable medium storing a program causing a computer to execute a process comprising
determining whether a storage period of a target document expires on a basis of a first table in which type information indicating a type of each document concerning medical care, creation department information indicating a department where the document is created, and the storage period determined by a period from a time when the document is reviewed are associated with each other using the type information and the creation department information about the target document;
determining whether the storage period of the target document expires on a basis of a second table in which medical care department information indicating a medical care department is associated with the storage period determined by the period from the time when the document concerning the medical care is reviewed using the medical care department information indicating the medical care department where the target document is reviewed; and
performing, if it is determined that the storage period of the target document expires, any of deletion of the target document from a memory in which the target document is stored, compression of the target document, and movement of the target document to another document memory.

7. An information processing method comprising:
determining whether a storage period of a target document expires on a basis of a first table in which type information indicating a type of each document concerning medical care, creation department information indicating a department where the document is created, and the storage period determined by a period from a time when the document is reviewed are associated with each other using the type information and the creation department information about the target document;
determining whether the storage period of the target document expires on a basis of a second table in which medical care department information indicating a medical care department is associated with the storage period determined by the period from the time when the document concerning the medical care is reviewed using the medical care department information indicating the medical care department where the target document is reviewed; and
performing, if it is determined that the storage period of the target document expires, any of deletion of the target document from a memory in which the target document is stored, compression of the target document, and movement of the target document to another document memory.
